(19) United States
(12) Patent Application Publication
(10) Pub. No.: US 2017/0155712 A1
(43) Pub. Date: Jun. 1, 2017

(54) METHOD AND DEVICE FOR UPDATING CACHE DATA

(71) Applicants: Le Holdings (Beijing) Co., Ltd., Beijing (CN); LETV SPORTS CULTURE DEVELOP(BEIJING) CO., LTD., Beijing (CN)

(72) Inventors: Chuanxiao PANG, Beijing (CN); Fei LU, Beijing (CN)

(21) Appl. No.: 15/246,528

(22) Filed: Aug. 24, 2016

Related U.S. Application Data
(63) Continuation of application No. PCT/CN2016/089482, filed on Jul. 8, 2016.

(30) Foreign Application Priority Data
Dec. 1, 2015 (CN) 201510864595.X

(51) Int. Cl. H04L 29/08; H04L 29/06; G06F 17/30

(52) U.S. Cl. CPC H04L 67/1036; G06F 17/30864; G06F 17/30321; G06F 17/30887; H04L 67/42; H04L 67/2842

(57) ABSTRACT

Disclosed are a method and a device for updating cache data. The method includes: according to data request information sent from a web server, sending, by a service server, response data corresponding to the data request information to the web server, and establishing a mapping relationship between a key and a data identity (ID); monitoring whether there is an update in the response data corresponding to the data ID; and if determining that there is an update in the response data corresponding to the data ID, obtaining the key based on the mapping relationship, and deleting the key and the response data corresponding to the key in the cache server according to the key.

### CROSS REFERENCE TO RELATED APPLICATIONS

This application is a continuation of International Application No. PCT/CN2016/089482, filed on Jul. 8, 2016, which is based upon and claims priority to Chinese Patent Application No. 201510864595.X, filed on Dec. 1, 2015, the entire contents of which are incorporated herein by reference.

### TECHNICAL FIELD

The present disclosure relates to internet technologies, and more particularly, to a method and a device for updating cache data.

### BACKGROUND

With proliferation of Internet, people's demands for access efficiency of web servers have increased, especially in applications of multiple parallel users in the Internet field. Previously accessed data are added into a cache server, because reading data from the cache server is faster than reading the same data from a service server.

At present, a web server can send a Uniform Resource Locator (URL) sent from a client to a service server as a key, and receives results corresponding to the URL sent from the service server. With the returned results as a value, the web server stores a key-value pair in a cache server. When storing the key-value pair in the cache server, the web server usually sets an expiration time for the key-value pair. If the expiration time for the key-value pair is not expired, when the client sends next request information regarding the key, the web server obtains the value corresponding to the key from the cache server, and sends the value to the client. This can reduce the load of the service server and latency for responding to the client.

The service server can identify different values using different data identities (IDs). However, if data (i.e., value) corresponding to a data ID in the service server changes and the client sends request information regarding the key within the expiration time, the data (i.e., value) obtained by the client is the old value (i.e., the value before the change) stored in the cache server. That is, if subsequent request information regarding the same key is sent within the expiration time, because the updating of the data (i.e., values) in the service server and the updating of the data (i.e., values) in the cache server are not synchronous, i.e., the data (i.e., values) stored in the cache server are not updated in real time, the user associated with the client may obtain inaccurate data. Particularly, when the user associated with the client wants to obtain data which requires high real time performance, for example, data about live sport events, or weather forecasts, the client may obtain inaccurate data, thereby resulting in a bad user experience.

### SUMMARY

The present disclosure provides a method and a device for updating cache data so as to realize synchronous updating of values in a cache server and values in a service server for the same key in the cache server and the service server and to improve user experience during obtaining of real-time data (values) by clients.

In a first aspect, embodiments of the present disclosure provide a method for updating cache data, implemented by a service server, including:

according to data request information sent from a web server, sending response data corresponding to the data request information to the web server, and establishing a mapping relationship between a key and a data ID, wherein the data request information includes the key which is generated by the web server, the web server stores the key and the response data corresponding to the key in a cache server after receiving the response data, and the data ID is a unique identifier of the response data stored by the service server;

monitoring whether there is an update in the response data corresponding to the data ID; and

if determining that there is an update in the response data corresponding to the data ID, obtaining the key based on the mapping relationship, and deleting the key and the response data corresponding to the key in the cache server according to the key.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for updating cache data mentioned by embodiments of the present disclosure.

In a third aspect, embodiments of the present disclosure provide a non-transitory computer-readable storage medium storing executable instructions that, when executed by an electronic device, cause the electronic device to perform any methods for updating cache data mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for updating cache data in accordance with some embodiments.

FIG. 2 is a schematic diagram showing data interactions among a client, a web server, a cache server and a service server in accordance with some embodiments.

FIG. 3 is a block diagram of a device for updating cache data in accordance with some embodiments.

FIG. 4 is a block diagram of another device for updating cache data in accordance with some embodiments.

FIG. 5 is a block diagram showing a structure of a service server in accordance with some embodiments.

FIG. 6 is a block diagram showing a structure of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

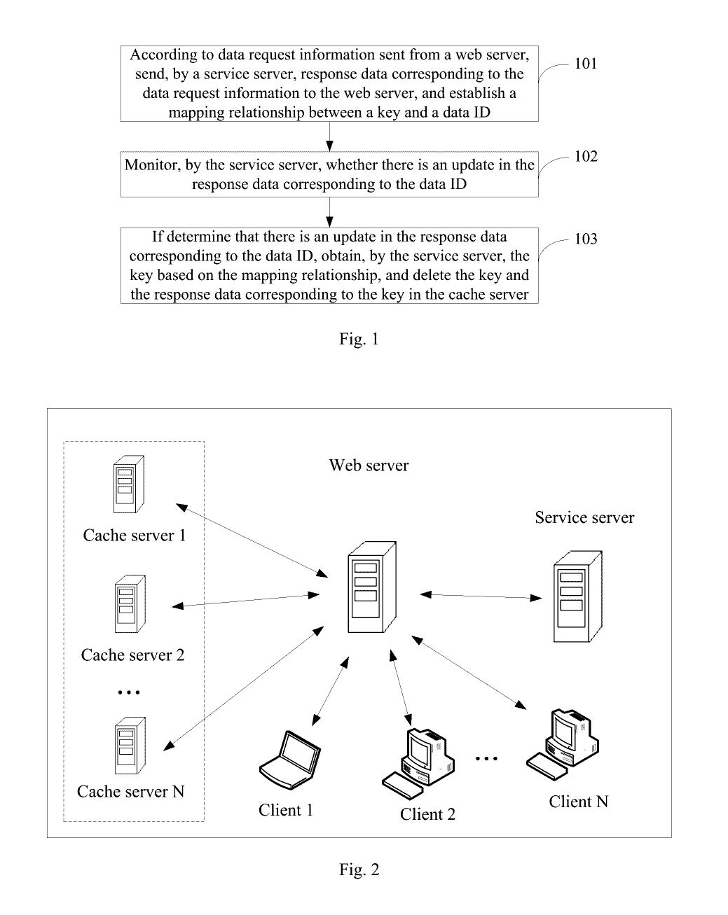

An embodiment of the present disclosure provides a method for updating cache data. The method can be applied in a service server. As shown in FIG. 1, the method can include the following steps.

In 101, according to data request information sent from a web server, the service server sends response data corresponding to the data request information to the web server, and establishes a mapping relationship between a key and a data ID.

The relationship among a client, a web server, a cache server and a service server will be described below in detail. For example, as shown in FIG. 2, N clients and N cache servers are shown, where N is a positive integer greater than 2. One of the clients sends data request information, which includes a URL, to the web server based on Hypertext Transfer Protocol (HTTP). After receiving the data request sent from the client, the web server generates a key according to the URL, and obtains response data (i.e., value) corresponding to the key from the cache server according to the key. If there exists the response data (i.e., value) corresponding to the key in the cache server, the web server obtains the response data (i.e., value), and sends the response data (i.e., value) to the client. If no response data (i.e., value) corresponding to the key exists in the cache server, the web server sends the data request information in which the key is carried to the service server. After receiving the data request information sent from the web server, the service server performs asynchronous processes. The asynchronous processes can include: responding to the data request information, sending the response data (i.e., value) corresponding to the data request information to the web server, and establishing a mapping relationship between the key and a data ID.

The data request information includes the key which is generated by the web server, the web server stores the key and the response data (i.e., value) corresponding to the key in the cache server after receiving the response data (i.e., value), and the data ID is a unique identifier of the response data (i.e., value) stored by the service server.

It should be noted that the data IDs and keys in the mapping relationship correspond to each other one to one. The mapping relationship is stored in the service server, and the keys correspond to the response data (i.e., value) which is stored in the cache server one to one. The web server, the cache server and the service server can communicate with each other. In embodiments of the present disclosure, if the cache server stores response data (i.e., value) corresponding to a key, it is indicated that the response data (i.e., value) is consistent with the response data (i.e., value) corresponding to the data ID in the service server, i.e., the response data (i.e., value) is the newest response data (or most recently updated response data).

Optionally, the web server can communicate and interact with a plurality of cache servers which are distributed high speed cache servers and capable of responding to data request information sent from clients in time. In order to reduce the loads of the cache servers and to guarantee that the cache servers can respond to data request information in time, before storing keys in the cache servers, the web server encrypts the keys, and then stores the keys randomly in the cache servers with the encrypted keys as random character strings. This can increase the dispersibility of the keys and thus avoid overlarge loads on the cache servers caused by over-concentrated keys. The encryption methods of the keys and corresponding values can include but not limited to: a Hash algorithm including Message-Digest Algorithm 5 (MD5). However, embodiments of the present disclosure are not limited to this.

It should be noted that keys are generated according to data request information, and however, because the keys are encrypted (which means that they are irreversible) for the purpose of reducing loads of cache servers, when the web server sends data request information to the service server, if only the keys are sent, the service server cannot recognize the specific data request information in the keys, and thereby cannot respond to the web server. Thus, when requesting data from the service server, the web server needs to carry the keys in the data request information.

For example, the data request information sent from a client includes a URL: http://api.1esports.com/sms/v1/matches/28845003?caller=1001, the web server takes the URL as the key, and performs MD5 encryption on the key. The encrypted key is: 9afbd22506afTh5cc6dd395a57b1471d. The web server adds the encrypted key into the data request information and sends the data request information to the service server, so that the service server can respond to the data request information, and meanwhile the service server can establish the mapping relationship between the key and a data ID.

In 102, the service server monitors whether there is an update in the response data corresponding to the data ID.

In embodiments of the present disclosure, the data ID in the service server does not change, but the response data (i.e., value) corresponding to data ID can change or be updated at any time. The time for the updating or change is random. Thus, the service server needs to monitor response data (i.e., value) corresponding to the data ID so as to determine whether there is an update in the response data (i.e., value) corresponding to the data ID.

In 103, if determining that there is an update in the response data corresponding to the data ID, the service server obtains the key based on the mapping relationship, and deletes the key and the response data corresponding to the key in the cache server.

If the web server does not find any update in the response data (i.e., value) corresponding to the data ID in step 102 and the cache server stores the response data (i.e., value), it is indicated that the response data (i.e., value) in the service server is consistent with the response data (i.e., value) stored in the cache server, and thus there is no need to make the response data (i.e., value) in the cache server become invalid actively. The active invalidity in embodiments of the present disclosure refers to actively deleting response data (i.e., value) even if the expiration time for the response data (i.e., value) is not expired. If the web server finds that there is an update in the response data (i.e., value) corresponding to the data ID and the cache server stores the response data (i.e., value), it is indicated that the response data (i.e., value) in the service server is not consistent with the response data (i.e., value) stored in the cache server, and thus it is needed to make the response data (i.e., value) in the cache server become invalid actively, so that the user associated with a client can obtain response data (i.e., value) which is updated in real time.

The service server can make the response data (i.e., value) in the cache server become invalid actively by the following steps. Firstly, based on the mapping relationship between the key and the data ID established in step 101, the service server searches and determines the key corresponding to the data ID. Then, according to the key, the service server obtains the response data (i.e., value) corresponding to the key. Finally, the service server deletes the key and the response data (i.e., value) corresponding to the key. When the client sends data request information corresponding to the key again, the web server restores the key and response data (i.e., value) corresponding to the key in the cache server.

In embodiments of the present disclosure, after receiving the response data (i.e., value) sent from the service server, the web server stores <key, value, expire> in the cache server. The expiration time “expire” is set by the web server. If the service server does not update the response data (i.e., value) within the expiration time “expire”, when the client sends data request information contains the key, the web server obtains the response data (i.e., value) from the cache server and sends the response data to the client. In the cache server, if the expiration time “expire” is expired, the cache deletes <key, value, expire>. For example, if the web server stores <key, value, expire> in the cache server at 10:00 and the expiration time is set as 10 minutes, when the web server receives data request information containing the key sent from a client 1 at 10:01, the web server obtains the response data (i.e., value) corresponding to the key from the cache server and sends the response data to the client 1; when the web server receives data request information containing the key sent from a client 2 at 10:30, the web server obtains response data (i.e., value) corresponding to the key from the cache server, and the returned response data (i.e., value) is null. At this time, because the expiration time “expire” is expired, the cache server has deleted <key, value, expire>, and when receiving the data request information from the client 2, there is no <key, value, expire> stored in the cache server.

In the methods for updating cache data provided by embodiments of the present disclosure, after receiving data request information sent by a web server, a service server performs asynchronous processes on the request information. Specifically, the service server sends response data (i.e., value) corresponding to the data request information to the web server, and establishes a mapping relationship between a key and a data ID; the data request information includes the key which is generated by the web server, the web server stores the key and the response data (i.e., value) corresponding to the key in a cache server after receiving the response data (i.e., value), and the data ID is a unique identifier of the response data (i.e., value) stored by the service server; based on the established mapping relationship between the key and the data ID, the service server monitors whether there is an update in the response data (i.e., value) corresponding to the data ID; if determining that there is an update in the response data (i.e., value) corresponding to the data ID, the service server obtains the key based on the mapping relationship, and deletes the key and the response data (i.e., value) corresponding to the key in the cache server. In this way, the response data (i.e., value) in the cache server becomes invalid actively. As compared with conventional technologies, by establishing the mapping relationship between the data ID and the key and monitoring the response data corresponding to the data ID in real time, the technical solutions provided by embodiments of the present disclosure can guarantee that the response data (i.e., value) obtained by a user associated with a client is the response data (i.e., value) which is updated in real time. Thus, the accuracy of the response data (i.e., value) obtained by the user associated with the client is increased, thereby resulting in an improved user experience.

To further extend and give more details about the above embodiments, the establishing of the mapping relationship between the key and the data ID in step 101 can be realized by the following approaches. However, embodiments of the present disclosure are not limited to these approaches.

In a first approach, the service server obtains the data ID from the data request information, and establishes the mapping relationship between the key and the data ID.

The data request information sent from the web server includes a URL, in which a data ID may exist, and thus when establishing the mapping relationship between the key and the data ID, the service server parses the data request information, obtains the URL included in the data request information, and determines whether there is a data ID in the URL; if there is a data ID in the URL, the service server obtains the data ID and establishes the mapping relationship between the data ID and the key.

Referring to the above mentioned example again, the data request information sent from a client includes a URL: http://api.1esports.com/sms/v1/matches/28845003?caller=1001, and the encrypted key is: 9afbd22506aff85cc6dd395a57b1471d. The service server can determine that the data ID in the URL is 28845003. Rather, the examples are provided for illustrative purposes, and embodiments of the present disclosure do not impose specific limitations on the contents of the URL, format parameters included in the URL and the encrypted key.

In embodiments of the present disclosure, the established mapping relationship between the data ID and the key can be stored in a redis database. As an example, Table 1 shows the mapping relationship between the data ID and the key stored in the redis database in embodiments of the present disclosure. Embodiments of the present disclosure do not impose specific limitations on the specific implementation and storage form for the service server to store the mapping relationship between the data ID and the key.

TABLE 1
redis database

| | | response | |
|---|---|---|---|
| | | data | |
| key | data ID | (value) | comments |
| 9afbd22506aff85cc6dd395a57b1471d | 28845003 | response | |
| | | data 1 | |
| 94m679506aff85cc6dd395a57b6571d | 26930703 | response | |
| | | data 2 | |
| . . . | . . . | | . . . |

In a second approach, the service server obtains the data ID from the response data (i.e., value) corresponding to the data request information, and establishes the mapping relationship between the key and the data ID.

In the service server, data IDs and response data (i.e., values) correspond to each other one to one. Thus, the service server can parse the response data (i.e., value), obtains and determines the data ID contained in the response data (i.e., value), and establishes the mapping between the key and the data ID. The establishing of the mapping relationship between the key and the data ID and the storage of the mapping relationship by the service server can be found in the above description regarding the first approach, and repeated descriptions are omitted here.

Further, when the service server updates the response data (i.e., value) corresponding to the data ID, editors in charge of the response data edit the response data (i.e., value). After the edition of the response data (i.e., value) is completed, the editors tap or click a preset updater component so as to realize the updating of the response data (i.e., value). From a technical point of view, when detecting that the editors tap or click the preset updater component, i.e., receiving an instruction for updating the response data (i.e., value), the service server updates the response data (i.e., value). Thus, in embodiments of the present disclosure, by monitoring the preset updater component, the service server can determine whether there is an update in the response data (i.e., value) corresponding to the data ID. Depending on the programming languages used by the service server, the preset updater component in embodiments of the present disclosure may vary. For example, the preset updater component can be a storage component, a updater component, a substitution component and the like, and embodiments of the present disclosure do not impose specific limitations on the preset updater component.

Further, the key and the response data (i.e., value) corresponding to the key are stored in the cache server, and the key and the data ID are stored in the service server. When deleting the key and the response data (i.e., value) corresponding to the key in the cache server according to the key, the service server calls a preset function interface, establishes an interaction relationship with the cache server, and based on the key which can be recognized by both the cache server and the service server, obtains the response data (i.e., value) corresponding to the key from the cache server and deletes the key and the response data (i.e., value) corresponding to the key. When deleting the key and the response data (i.e., value) corresponding to the key, the service server firstly determines a field in the cache server where the key is stored by traversing according to the key, and then determines the response data (i.e., value) corresponding to the key in the field where the key is stored, and deletes the key and response data (i.e., value). Embodiments of the present disclosure do not impose specific limitations on the implementation for the service server to delete the key and the response data (i.e., value) corresponding to the key in the cache server.

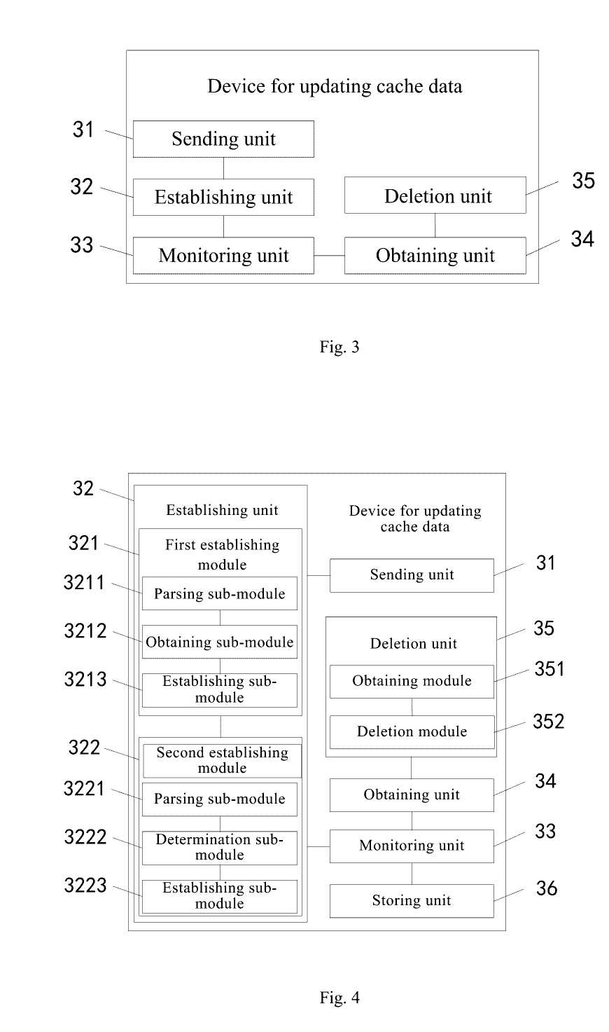

An embodiment of the present disclosure provides a device for updating cache data to implement the above method described in connection with FIG. 1. The device is applied in a service server. As shown in FIG. 3, the device can include a sending unit 31, an establishing unit 32, a monitoring unit 33, an obtaining unit 34 and a deletion unit 35.

The sending unit 31 is configured to, according to data request information sent from a web server, send response data corresponding to the data request information to the web server. It should be noted that the data IDs and keys in the mapping relationship correspond to each other one to one. The mapping relationship is stored in the service server, and the keys correspond to the response data (i.e., value) which is stored in the cache server one to one. The web server, the cache server and the service server can communicate and interact with each other. In embodiments of the present disclosure, if the cache server stores response data (i.e., value) corresponding to a key, it is indicated that the response data (i.e., value) is consistent with the response data (i.e., value) corresponding to the data ID in the service server, i.e., the response data (i.e., value) is the newest response data (or most recently updated response data).

The establishing unit 32 is configured to establish a mapping relationship between a key and a data ID. The data request information includes the key which is generated by the web server, the web server stores the key and the response data corresponding to the key in a cache server after receiving the response data, and the data ID is a unique identifier of the response data stored by the service server.

The monitoring unit 33 is configured to monitor whether there is an update in the response data corresponding to the data ID in the mapping relationship established by the establishing unit 32. The data ID does not change, but the response data (i.e., value) corresponding to data ID can change or be updated at any time. The time for the updating or change is random. Thus, it is needed to monitor response data (i.e., value) corresponding to the data ID so as to determine whether there is an update in the response data (i.e., value) corresponding to the data ID.

The obtaining unit 34 is configured to, if the monitoring unit 33 determines that there is an update in the response data corresponding to the data ID, obtain the key based on the mapping relationship.

The deletion unit 35 is configured to delete the key and the response data corresponding to the key in the cache server according to the key obtained by the obtaining unit 34. Thus, a user associated with the client can obtain data (i.e., value) which is updated in real time.

Further, as shown in FIG. 4, the establishing unit 32 includes a first establishing module 321 or a second establishing module 322.

The first establishing module 321 is configured to obtain the data ID from the data request information, and establish the mapping relationship between the key and the data ID.

The second establishing module 322 is configured to obtain the data ID from the response data corresponding to the data request information, and establish the mapping relationship between the key and the data ID.

Further, as shown in FIG. 4, the first establishing module 321 includes a parsing sub-module 3211, an obtaining sub-module 3212, and an establishing sub-module 3213.

The parsing sub-module 3211 is configured to parse the data request information.

The obtaining sub-module 3212 is configured to, after the parsing sub-module 3211 parses the data request information, obtain the data ID in a Uniform Resource Locator (URL).

The establishing sub-module 3213 is configured to establish the mapping relationship between the key and the data ID obtained by the obtaining sub-module 3212.

Further, as shown in FIG. 4, the second establishing module 322 includes a parsing sub-module 3221, a determination sub-module 3222 and an establishing sub-module 3223.

The parsing sub-module 3221 is configured to parse the response data corresponding to the data request information.

The determination sub-module 3222 is configured to, after the parsing sub-module 3221 parses the response data corresponding to the data request information, determine the data ID corresponding to the response data.

The establishing sub-module 3223 is configured to establish the mapping relationship between the key and the data ID determined by the determination sub-module 3222.

Further, as shown in FIG. 4, the device can further include a storing unit 36.

The storing unit 36 is configured to, after the establishing unit 32 establishes the mapping relationship between the key and the data ID, store the mapping relationship a database.

Further, the monitoring unit 33 is further configured to monitor a preset updater component to determine whether there is an update in the response data corresponding to the data ID. The preset updater component is configured to update the response data corresponding to the data ID.

Further, as shown in FIG. 4, the deletion unit 35 includes an obtaining module 351 and a deletion module 352.

The obtaining module 351 is configured to call a preset function interface to obtain the key and the response data corresponding to the key in the cache server.

The deletion module 352 is configured to delete the key and the response data corresponding to the key obtained by the obtaining module 351.

In the devices for updating cache data provided by embodiments of the present disclosure, after receiving data request information sent by a web server, a service server performs asynchronous processes on the request information. Specifically, the service server sends response data corresponding to the data request information to the web server, and establishes a mapping relationship between a key and a data ID; the data request information includes the key which is generated by the web server, the web server stores the key and the response data corresponding to the key in a cache server after receiving the response data, and the data ID is a unique identifier of the response data stored by the service server; based on the established mapping relationship between the key and the data ID, the service server monitors whether there is an update in the response data corresponding to the data ID; if determining that there is an update in the response data corresponding to the data ID, the service server obtains the key based on the mapping relationship, and deletes the key and the response data corresponding to the key in the cache server. In this way, the response data in the cache server becomes invalid actively. As compared with conventional technologies, by establishing the mapping relationship between the data ID and the key and monitoring the response data corresponding to the data ID in real time, the technical solutions provided by embodiments of the present disclosure can guarantee that the response data obtained by a user associated with a client is the response data which is updated in real time. Thus, the accuracy of the response data obtained by the user associated with the client is increased, thereby resulting in an improved user experience.

It should be noted that the functions of respective units or modules in the above devices for updating cache data according to embodiments of the present disclosure can be realized by hardware processors.

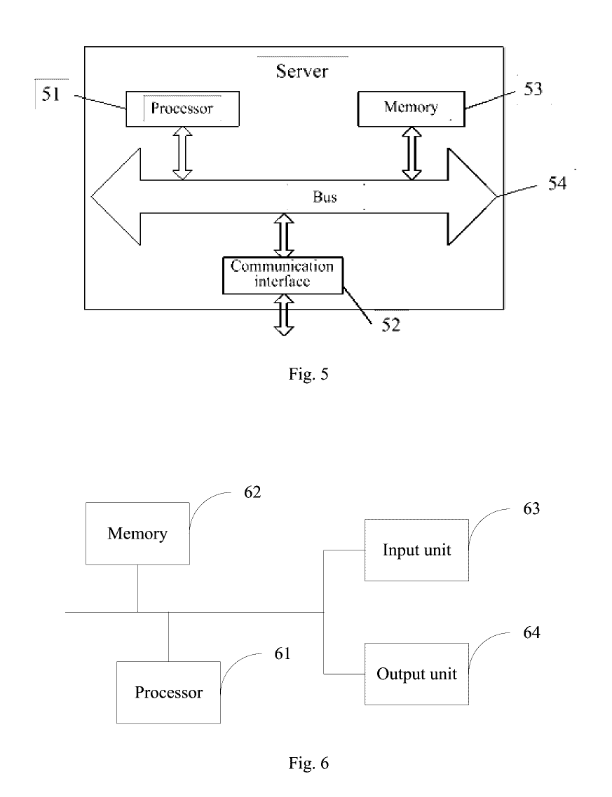

As an example, the above devices for updating cache data can be service servers. FIG. 5 is a block diagram showing a physical structure of a service server in accordance with an embodiment of the present disclosure. The server can include a processor 51, a communication interface 52, a memory 53 and a bus 54. The processor 51, the communication interface 52 and the memory 53 communicate with each other via the bus 54. The communication interface 52 may be used for information transmission between the server and a client. The processor 51 calls logic instructions in the memory 53 to perform the following method: according to data request information sent from a web server, sending, by the service server, response data corresponding to the data request information to the web server, and establishing a mapping relationship between a key and a data ID, wherein the data request information includes the key which is generated by the web server, the web server stores the key and the response data corresponding to the key in a cache server after receiving the response data, and the data ID is a unique identifier of the response data stored by the service server; monitoring whether there is an update in the response data corresponding to the data ID; and if determining that there is an update in the response data corresponding to the data ID, obtaining the key based on the mapping relationship, and deleting the key and the response data corresponding to the key in the cache server according to the key.

In addition, the logic instructions in the memory 53 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for updating cache data mentioned by embodiments of the present disclosure.

FIG. 6 is a block diagram of an electronic device which is configured to perform the methods for updating cache data according to an embodiment of the present disclosure. As shown in FIG. 6, the device includes: one or more processors 61 and memory 62. A processor 61 is showed in FIG. 6 for an example.

Device which is configured to perform the methods for updating cache data can also include: input unit 63 and output unit 64.

Processor 61, memory 62, input unit 63 and output unit 64 can be connected by BUS or other methods, and BUS connecting is showed in FIG. 6 for an example.

Memory 62 can be used for storing non-transitory software program, non-transitory computer executable program and modules as a non-transitory computer-readable storage medium, such as corresponding program instructions/modules for the methods for updating cache data mentioned by embodiments of the present disclosure (such as shown in FIG. 3, sending unit 31, establishing unit 32, monitoring unit 33, obtaining unit 34 and deletion unit 35). Processor 61 performs kinds of functions and updating cache data of the electronic device by executing non-transitory software program, instructions and modules which are stored in memory 62, thereby realizes the methods for updating cache data mentioned by embodiments of the present disclosure.

Memory 62 can include program storage area and data storage area, thereby the operating system and applications required by at least one function can be stored in program storage area and data created by using the device for updating cache data can be stored in data storage area. Furthermore, memory 62 can include high speed Random-access memory (RAM) or non-volatile memory such as magnetic disk storage device, flash memory device or other non-volatile solid state storage devices. In some embodiments, memory 62 can include long-distance setup memories relative to processor 61, which can communicate with the device for updating cache data by networks. The examples of said networks are including but not limited to Internet, Intranet, LAN, mobile Internet and their combinations.

Input unit 63 can be used to receive inputted number, character information and key signals causing user configures and function controls of the device for updating cache data. Output unit 64 can include a display screen or a display device.

The said module or modules are stored in memory 62 and perform the methods for updating cache data when executed by one or more processors 61.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for updating cache data, implemented by a service server, comprising:
according to data request information sent from a web server, sending response data corresponding to the data request information to the web server, and establishing a mapping relationship between a key and a data identity (ID), wherein the data request information comprises the key which is generated by the web server, the web server stores the key and the response data corresponding to the key in a cache server after receiving the response data, and the data ID is a unique identifier of the response data stored by the service server;
monitoring whether there is an update in the response data corresponding to the data ID; and
if determining that there is an update in the response data corresponding to the data ID, obtaining the key based on the mapping relationship, and deleting the key and the response data corresponding to the key in the cache server according to the key.

2. The method according to claim 1, wherein the establishing of the mapping relationship between the key and the data ID comprises:
obtaining the data ID from the data request information, and establishing the mapping relationship between the key and the data ID; or
obtaining the data ID from the response data corresponding to the data request information, and establishing the mapping relationship between the key and the data ID.

3. The method according to claim 2, wherein the obtaining of the data ID from the data request information, and establishing of the mapping relationship between the key and the data ID comprises:
parsing the data request information, and obtaining the data ID in a Uniform Resource Locator (URL); and
establishing the mapping relationship between the key and the data ID.

4. The method according to claim 2, wherein the obtaining of the data ID from the response data corresponding to the data request information, and the establishing of the mapping relationship between the key and the data ID comprises:
parsing the response data corresponding to the data request information, and determining the data ID corresponding to the response data; and
establishing the mapping relationship between the key and the data ID.

5. The method according to claim 1, wherein after the establishing of the mapping relationship between the key and the data ID, the method further comprises:
storing the mapping relationship in a database.

6. The method according to claim 5, wherein monitoring of whether there is an update in the response data corresponding to the data ID comprises:
monitoring a preset updater component to determine whether there is an update in the response data corresponding to the data ID, wherein the preset updater component is configured to update the response data corresponding to the data ID.

7. The method according to claim 6, wherein the deleting of the key and the response data corresponding to the key in the cache server according to the key comprises:
calling a preset function interface to obtain the key and the response data corresponding to the key in the cache server; and
deleting the key and the response data corresponding to the key.

8. An electronic device, comprising:
at least one processor; and
a memory communicably connected with the at least one processor for storing instructions executable by the at least one processor, wherein execution of the instructions by the at least one processor causes the at least one processor to:
according to data request information sent from a web server, send response data corresponding to the data request information to the web server, and establish a mapping relationship between a key and a data identity (ID), wherein the data request information comprises the key which is generated by the web server, the web server stores the key and the response data corresponding to the key in a cache server after receiving the response data, and the data ID is a unique identifier of the response data stored by the service server;
monitor whether there is an update in the response data corresponding to the data ID; and
if determining that there is an update in the response data corresponding to the data ID, obtain the key based on the mapping relationship, and delete the key and the response data corresponding to the key in the cache server according to the key.

9. The electronic device according to claim 8, wherein the establishing of the mapping relationship between the key and the data ID comprises:
obtaining the data ID from the data request information, and establishing the mapping relationship between the key and the data ID; or
obtaining the data ID from the response data corresponding to the data request information, and establishing the mapping relationship between the key and the data ID.

10. The electronic device according to claim 9, wherein the obtaining of the data ID from the data request information, and establishing of the mapping relationship between the key and the data ID comprises:
parsing the data request information;
obtaining the data ID in a Uniform Resource Locator (URL); and
establishing the mapping relationship between the key and the data ID.

11. The electronic device according to claim 9, wherein the obtaining of the data ID from the response data corresponding to the data request information, and the establishing of the mapping relationship between the key and the data ID comprises:
parsing the response data corresponding to the data request information;
determining the data ID corresponding to the response data; and
establishing the mapping relationship between the key and the data ID.

12. The electronic device according to claim 8, wherein after the establishing of the mapping relationship between the key and the data ID, wherein the instructions are executed to cause the at least one processor to:
store the mapping relationship in a database.

13. The electronic device according to claim 12, wherein monitoring of whether there is an update in the response data corresponding to the data ID comprises:
monitoring a preset updater component to determine whether there is an update in the response data corresponding to the data ID, wherein the preset updater component is configured to update the response data corresponding to the data ID.

14. The electronic device according to claim 13, wherein the deleting of the key and the response data corresponding to the key in the cache server according to the key comprises:
calling a preset function interface to obtain the key and the response data corresponding to the key in the cache server; and
deleting the key and the response data corresponding to the key.

15. A non-transitory computer-readable storage medium storing executable instructions that, when executed by an electronic device, cause the electronic device to:
according to data request information sent from a web server, send response data corresponding to the data request information to the web server, and establish a mapping relationship between a key and a data identity (ID), wherein the data request information comprises the key which is generated by the web server, the web server stores the key and the response data corresponding to the key in a cache server after receiving the response data, and the data ID is a unique identifier of the response data stored by the service server;
monitor whether there is an update in the response data corresponding to the data ID; and
if determining that there is an update in the response data corresponding to the data ID, obtain the key based on the mapping relationship, and delete the key and the response data corresponding to the key in the cache server according to the key.

16. The non-transitory computer-readable storage medium according to claim 15, wherein the establishing of the mapping relationship between the key and the data ID comprises:
obtaining the data ID from the data request information, and establishing the mapping relationship between the key and the data ID; or
obtaining the data ID from the response data corresponding to the data request information, and establishing the mapping relationship between the key and the data ID.

17. The non-transitory computer-readable storage medium according to claim 16, wherein the obtaining of the data ID from the data request information, and establishing of the mapping relationship between the key and the data ID comprises:
parsing the data request information;
obtaining the data ID in a Uniform Resource Locator (URL); and
establishing the mapping relationship between the key and the data ID.

18. The non-transitory computer-readable storage medium according to claim 16, wherein the obtaining of the data ID from the response data corresponding to the data request information, and the establishing of the mapping relationship between the key and the data ID comprises:
parsing the response data corresponding to the data request information;
determining the data ID corresponding to the response data; and
establishing the mapping relationship between the key and the data ID.

19. The non-transitory computer-readable storage medium according to claim 15, wherein after the establishing of the mapping relationship between the key and the data ID, wherein the executable instructions are executed to cause the electronic device to:
store the mapping relationship in a database.

20. The non-transitory computer-readable storage medium according to claim 19, wherein monitoring of whether there is an update in the response data corresponding to the data ID comprises:
monitoring a preset updater component to determine whether there is an update in the response data corresponding to the data ID, wherein the preset updater component is configured to update the response data corresponding to the data ID.
